(19) United States
(12) Patent Application Publication
(10) Pub. No.: US 2003/0144890 A1
(43) Pub. Date: Jul. 31, 2003

(54) Parking management system and method

(76) Inventor: Noah Dan, Potomac, MD (US)

Correspondence Address: Noah Dan, 8813 Hidden Hill Lane, Potomac, MD, 20854, US

(21) Appl. No.: 10/066,215

(22) Filed: Jan. 31, 2002

(51) Int. Cl. G06F 17/60

(52) U.S. Cl. 705/5

(57) ABSTRACT

A parking management system and method is disclosed wherein a user of the system can reserve or bid on a parking space within a parking facility or participate in a loyalty program whereby the user is rewarded for using the parking management system of this invention.

### FIELD OF THE INVENTION

The present invention relates to parking management systems, in particular, to an automated parking reservation system and method.

### BACKGROUND OF THE INVENTION

Parking in an urban or municipal environment has become increasing difficult, if not impossible, problem for many commuters. These problems include parking facilities filling up early in the morning, locating parking facilities, the lot being full, and locating parking facilities near a commuter's final destination. It is often the case that commuters must waste value time in trying to find a parking space near their destination.

This problem has been addressed in the prior art. For example, Zeitman (U.S. Pat. No. 5,940,481) discloses a parking management system wherein a user of the system would make a reservation for a parking system prior to entering the parking facility and be responsible for locating a vacate parking space and report the space to the controller of the system. This system has several drawbacks. First, by requiring the user to locate a vacate space in the parking facility, the user loses valuable time in one's day by having to circle the parking facility in order to find a parking spot. Second, once a spot is located and the user parks their car in the spot, the user is then required to notify the system that he has parked their car in a specific location thereby removing that spot from the system's inventory of available spots. Additionally, by having a user locate an available parking space additional and unnecessary congestion is created.

In U.S. Pat No. 5,091,727, Mahmood discloses a fully optimized automatic parking facility management system wherein the system determines, upon a vehicle entering the facility, desirable vacated parking spaces and prints a parking record including a computerized parking space location. However, the system is based on a first come, first serve basis and does not provide a way in which parking spaces can be reserved prior to the vehicle entering the facility.

In U.S. Pat No. 6,107,942, Yoo et al discloses a parking guidance and management system wherein the system provides graphical information regarding the relative availability of parking spaces within a parking garage or other large facility. Parking space availability is determined using either a single camera per parking space or a single camera monitoring a plurality of spaces. The information concerning the availability of parking spaces is displayed at strategically located displays along the way to the available space. However, this system does not allow the ability to reserve parking spaces and does not tell the driver at the time of entering the parking facility where an available parking space is located.

In U.S. Pat No. 5,432,508, Jackson discloses a technique for facilitating and monitoring vehicle parking wherein sensors are used to determine the availability of vacant parking spaces and vehicle operators are alerted at a substantial distance to such availability. However, this system is does not allow the ability to reserve parking spaces and does not tell the driver at the time of entering the parking facility where an available parking space is located.

In U.S. Pat No. 5,504,314, Farmont discloses a monitoring and/or directing system for parking areas wherein incoming vehicles are guided specifically to empty parking spaces in order to reduce theft. However, this system does not allow parking spaces to be reserved or bided on.

### SUMMARY OF THE INVENTION

It is therefore an object of this invention to provide a parking management system, which is devoid of the above-mentioned shortcomings.

A further object of this invention is to provide a novel parking management system.

Another object of this invention is to provide a parking management system whereby parking spaces can be reserved.

Still another object of this invention is to provide a parking management system whereby parking spaces can be bided on or traded.

These and additional objects of the present invention are accomplished generally by a parking management system whereby parking spaces can be reserved prior to a vehicle entering a parking facility. As a user of the system is preparing for a trip or on the way to a municipal, he can log into the system and reserve a parking space near to his destination using a variety of devices, including a cellular phone, personal digital assistant, or other such personal electronic device from either his home, car, or other transportation vehicle. When the user initiates his account with the system, he supplies his credit card number or other account information such as a checking account to pay for and reserve the parking space. As the user of the system approaches the parking facility, he swipes his credit card or smart card which is linked to the user and in return the system prints out a parking pass with has assigned parking space number encoded therein in both human and machine readable form. At the exit, the user swipes his parking pass and his credit card gets charged. The parking spaces within the facility are monitored using a plurality of wireless digital cameras. The outputs of the digital cameras are fed to a computer running an image recognition software which are able to determine whether a particular parking space is vacate or occupied. Preferably, the cameras transmit 1 frame per minute using the 802.11x wireless protocol or other similar protocols to the computer. Control of the cameras preferably occurs along a separate route such as through the power cables.

Additionally in accordance with a preferred embodiment of the present invention, the parking management system allows participates of the system to participate in an auction of parking spaces. Within a parking facility participating in the management system of the present invention, some parking spots are not permanently assigned and are available to be used in this auction type system. Given the location of these unassigned parking spaces to exits and elevators, an initial price is determined. A higher price is set for those spots, which are regarded as better since their location is nearer to the exit of the parking facility. Each auction is established a set time period for which bidding can occur. The user with the highest bid at the end of that time period wins the parking space.

Further in accordance with a preferred embodiment of the present invention, the parking management system allows participates to participate in a loyalty program. The parking management system will allow users of the system to park in other participating parking facilities and will receive discounts when choosing other participating facilities. While a user who normally has a periodic parking pass, whether it be monthly or bi-monthly, with a particular parking facility chooses to use another participating parking facility, then that parking space can be “sub leased” at an hourly rate.

The foregoing and additional objects and advantages of the invention together with the structure characteristics thereof, which is only briefly summarized in the foregoing passages, become more apparent to those skilled in the art upon reading the detailed description and preferred embodiments, which follow in this specification, taken together with the illustration thereof presented in the representative accompanying drawings.

### BRIEF DESCRIPTION OF THE DRAWINGS

FIG. 1 is a simplified pictorial illustration of system architecture of the parking management system, constructed and operated in accordance with a preferred embodiment of the present invention.

FIG. 2 is an illustration of the occupancy classification process of parking spaces in accordance with a preferred embodiment of the present invention.

FIG. 3 is a simplified flow chart of a method for reserving a parking space within the parking management system, in accordance with a preferred embodiment of the present invention.

FIG. 4 is a simplified flow chart of a method of biding on parking spaces within the parking management system, in accordance with a preferred embodiment of the present invention.

FIG. 5 is a simplified flow chart of a method of participating in a loyalty program within the parking management system, in accordance with a preferred embodiment of the present invention.

### DETAILED DESCRIPTION OF THE INVENTION AND PREFERRED EMBODIMENTS

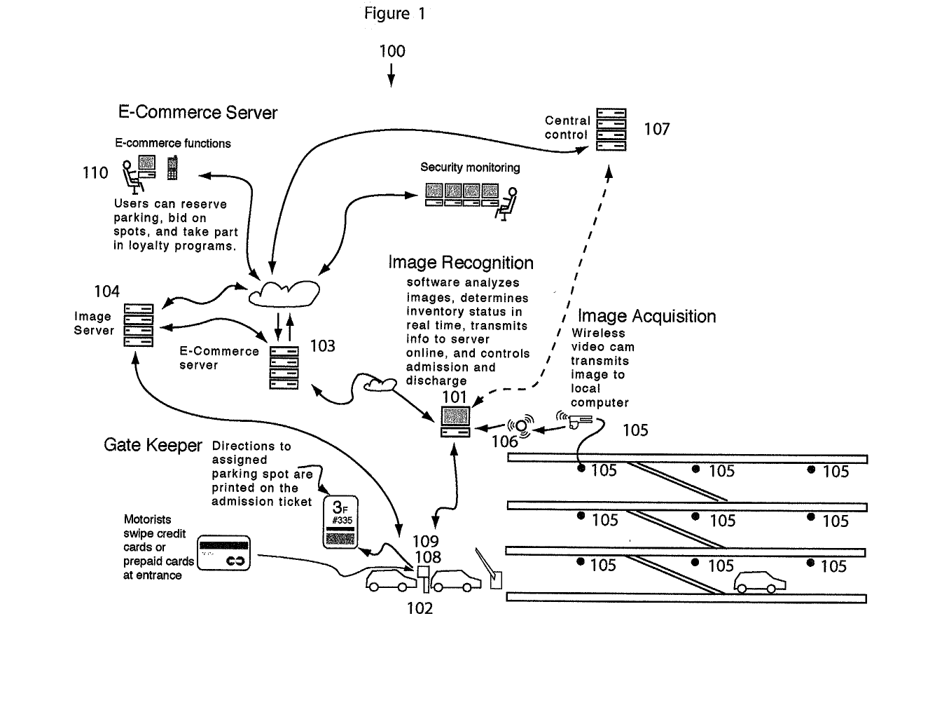

Reference is now made to FIG. 1, which illustrates parking management system architecture 100, constructed and operative in accordance with a preferred embodiment of the present invention. Parking management system architecture 100 preferably includes an image acquisition system 101, gate keeper 102, image server 103, and an e-commerce server 104. The image acquisition system 101 preferably comprises a plurality of video cameras 105, a relay station 106, and a central control unit 107. The image server 103, e-commerce server 104, and central control unit 107 of the image acquisition system can be either separate entities communicating using standard data communication protocols as shown in FIG. 1 or could be contained in one system and share database 107. Database 107 preferably includes any information pertinent to monitoring and/billing use of parking facilities, such as parking facility identity, parking facility availability of a certain region, vehicle identification, user identification, billing information, and time related information of use of a parking facility. The gate keeper 102 preferably comprises smart card reader 108 and ticket dispenser 109.

Central control unit 107 communications with at least one user interface unit 110 via a wired or wireless telephone link, which may include telephone lines, wireless telephone links, such as the cellular network, communication network systems, such as the Internet, and/or citizen band radio. Depending on the type of communication chosen, central control unit may include any type of telephone exchange, LAN or transceiver. User interface unit 110 may include a public telephone, a mobile telephone, or computer terminal connected to a modem or computer network (not shown), for example.

Additionally in accordance with a preferred embodiment of the present invention, parking management system 100 includes billing apparatus for billing a user of the parking facility. Billing apparatus may include any type of system or software for generating debit notes and communicating debits.

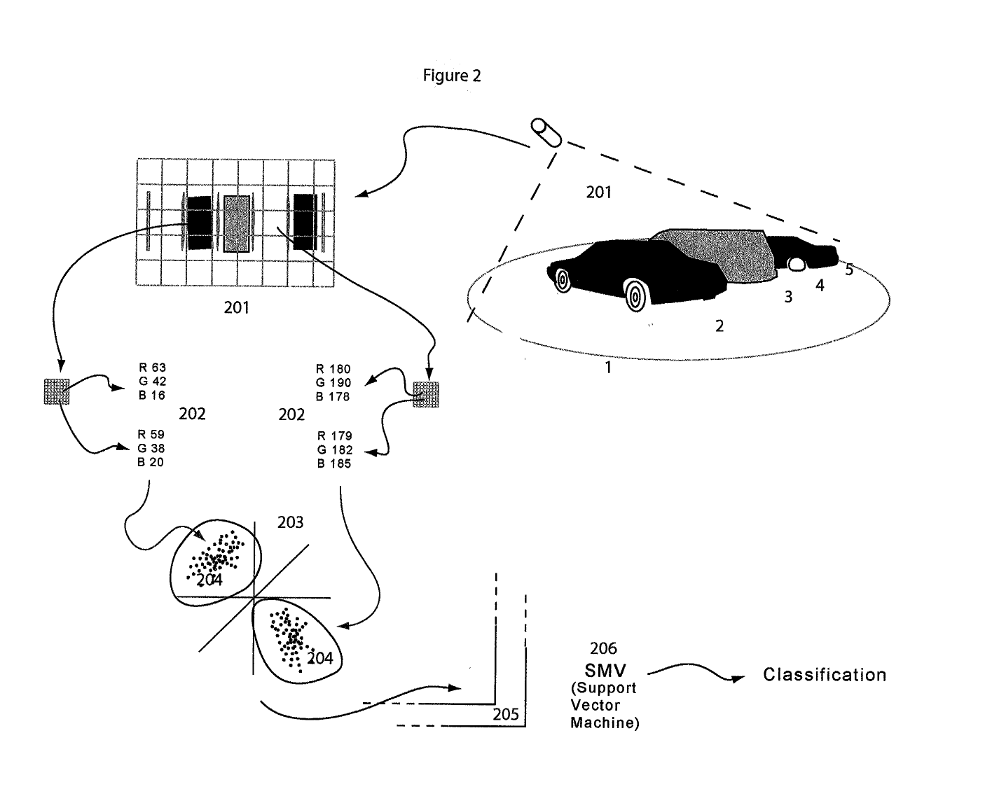

The plurality of video cameras 105 of the image acquisition system 101 is central in determining in real time whether a particular parking space is vacate or occupied. Typically, an individual camera monitors from 8 to 16 spaces depending on the layout of the parking facility. FIG. 2 is an illustration of the occupancy classification process of parking spaces in accordance with a preferred embodiment of the present invention. One preferred way for a video camera to differentiate whether a parking space is occupied or not will be described. For each parking space, the main region of interest 201 is a pixel area that always corresponds to ground surface when the space is empty and to a part of a vehicle when the space is occupied. The classification of the state of a particular parking space amounts to determining whether the region of interest (ROI) is surface or vehicle. The region of interest is characterized by a feature vector 202 whose components define the textures observed in that region of the image. This feature vector can be represented as a point in a high-dimensional space 203. As illumination conditions vary on the vacant ground surface, each measurement in the image when the parking space is empty creates a new point, so that a “cloud” of points 204 is generated over a period of time. During a training period 205, all of these points will be labeled by an operator as a representation of the ground surface class. Similarly, when the space is occupied by a vehicle, “clouds” of points are generated in feature space that can be labeled as representative of the vehicle class. A Support Vector Machine (SVM) classifier 206, as known in the art, is used to define optimal boundaries between the ground surface and vehicle classes. When the system is switched from training to operational mode, an observation of an ROI produces a point that can be classified either as ground surface or vehicle depending on whether it falls on one side of a border or the other. This output of the classifier determines whether a space is vacant or occupied.

Another preferred way to differentiate the vacancy of parking spaces involves the use of a scanning laser diode in conjunction with the video camera. By analyzing the reflected or scattered laser light from the either the vehicle or ground surface, the image acquisition system can get a detailed map of a section of the parking facility.

Still another preferred way in which a video camera differentiates parking space vacancy is by training the software of the image acquisition system to acquire a particular shape of a vehicle part, such as the vehicle's license plate.

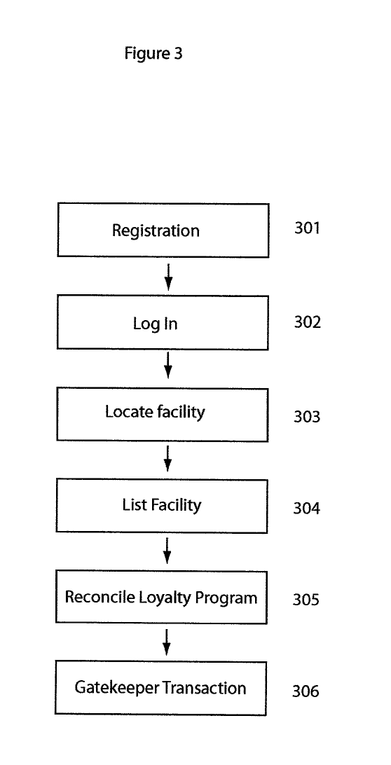

Reference is now made to FIG. 3, which illustrates, in flow chart format, a method for reserving a parking space, in accordance with a preferred embodiment of the present invention. A user 301 registers with the parking management system by supplying identifying information such as name, address, credit or bank account information that is used to pay for the parking space. After registration, the user logs into the parking management system 302. The user can now reserve a parking space with member parking facilities. The user locates the nearest facility by typing in an address 303 or selects the member parking facility from a list in the system's database 304. The system then checks the user against its database to see if the user is a member of a loyalty program 305. If so, certain discounts may be available for the user. As the user approaches the parking facility at which a parking space has previously been reserved, the user swipes the card upon which the reservation was made at the gatekeeper and is given a parking assignment 306 and alternatively a map to the parking space. Alternatively, the user can reserve the parking space using a cellular phone, a computer within the user's vehicle.

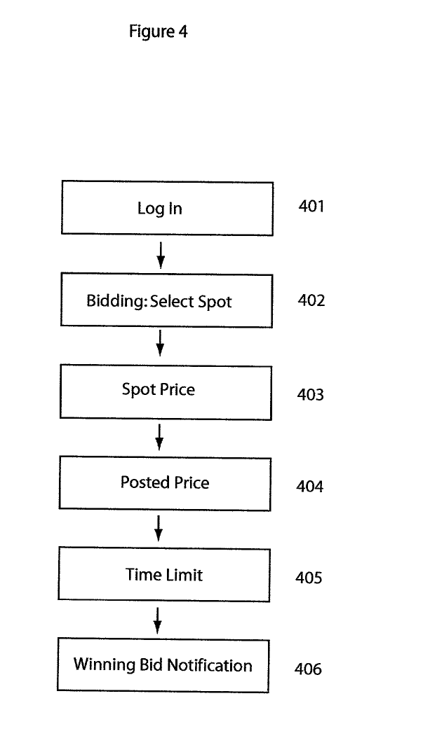

Reference is now made to FIG. 4, which illustrates, in flow chart format, a method for bidding on parking spaces, in accordance with a preferred embodiment of the present invention. When a user of the system logs in 401, the user is given the option of participating in bidding for spaces. The user selects a parking space within a list of member facilities 402 and bids an amount higher then the initial offering price of the parking space 403. For example, the initial offering price is $100.00. The user desiring that parking space, bids $125.00 and that price becomes the current amount that must be outbid for someone else to have that parking space. The newly bid price is posted and a time limit by which this particular auction will be closed 404. Once the time limit expires 405, the user with the highest bid at the end of that time period wins the parking space 406.

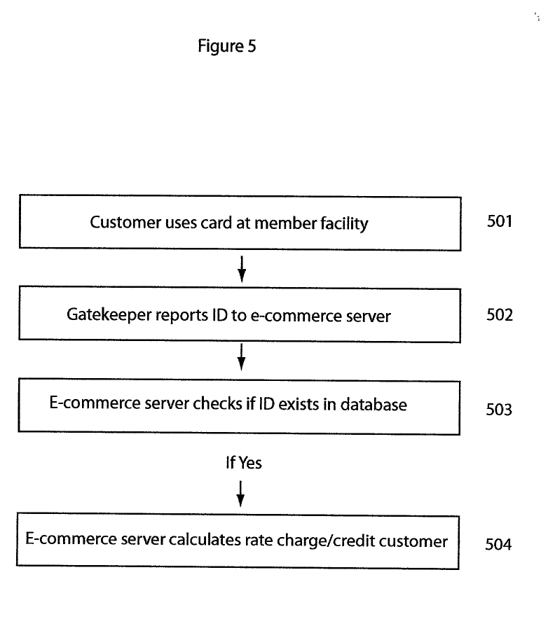

Reference is now made to FIG. 5, which illustrates, in flow chart format, a method for customer participation in a loyalty program, in accordance with a preferred embodiment of the present invention. At 501, the customer uses his card at a member parking facility. Once the card is swiped, the gatekeeper reports customer's ID to the ecommerce server 502. The ecommerce server checks if the reported ID exists in the database 503. If the ID does exist, the ecommerce server calculates proper rate to credit the customer 504.

The present embodiments of this invention are thus to be considered in all respects as illustrative and not restrictive; the scope of the invention being indicated by the appended claims rather than by the foregoing description. All changes that come within the meaning and range of equivalency of the claims are intended to be embraced therein.

I claim:

1. A method for parking management comprising:
providing a plurality of parking spaces at a multiplicity of disperse parking facilities;
monitoring said plurality of parking spaces with a multiplicity of video cameras;
reserving a parking space within said parking facility;
assigning a parking space with said parking facility to a user;
parking a vehicle at said reserved parking space.

2. The method according to claim 1, further comprising, prior to the step of parking, giving a vehicle an assigned parking space number.

3. The method according to claim 1, wherein said reserving is done by using a credit card, a check card, or a bank account.

4. A system for parking management comprising:
a plurality of parking spaces at a multiplicity of disperse parking facilities;
a plurality of video cameras monitoring at least two parking spaces within said parking facilities;
a controller located at said parking facility and in communication with said video cameras wherein said controller determine in real time or near real time whether said parking space is occupied;
a server in communication with said controller and said plurality of video camera wherein said server includes a database of user information and wherein said user communicates with said server to reserve a parking space within said parking facilities;
a ticket dispenser in communication with said server and controller which issues parking tickets to said user wherein said ticket contains an assigned parking spot location.

5. The system of claim 4, wherein the controller is in communication with a ticket dispenser at an entrance to said parking facility.

6. The system of claim 4, wherein the controller includes a Support Vector Machine classifier.

7. An auction method, comprising the following steps:
receiving bidding information from remote bidders, the bidding information including a desired price, location of parking facility, location of parking space within said parking facility, and a highest possible price for each remote bidder; and
conducting an automated auction procedure whereby the desired prices included in said bidding information are compared to determine an initial highest price;
wherein, if two bidders have competing desired prices, a successful bidder is determined on the basis of the largest highest possible price included in said bidding information; but if no bidders have competing desired prices, a successful bidder is determined on the basis of the largest desired price included in said bidding information.

8. The method as claimed in claim 7, wherein participation of the remote bidders in the auction is effected by the steps of:
displaying auction information to the remote bidders, said auction information being received by the remote bidders via either a hard-wired or wireless connection;
each of the bidders selecting an auction subject;
creating, for said selected subject, the auction ordering information including the desired price, the location of the parking facility, the location of the parking space within said parking facility, and the highest price in competition for the desired price; and
transmitting said auction information to an auctioneer terminal.
